(19) United States
(12) Patent Application Publication
(10) Pub. No.: US 2016/0179828 A1
(43) Pub. Date: Jun. 23, 2016

(54) REVISION MANAGEMENT

(71) Applicant: International Business Machines Corporation, Armonk, NY (US)

(72) Inventors: Richard R. Ellis, Winchester (GB); Matthew W. Leming, Romsey (GB); Geoffrey S. Pirie, Winchester (GB)

(21) Appl. No.: 14/577,249

(22) Filed: Dec. 19, 2014

(51) Int. Cl. G06F 17/30

(52) U.S. Cl. CPC G06F 17/30082; G06F 17/30165

(57) ABSTRACT

A computer-implemented method for revision management of files includes receiving a first file including a first revision, wherein the first revision differentiates the first file from a second file. A first change-identifier is assigned to the first revision. The first change-identifier assigned to the first revision is negated, and it is determined whether the negated first change-identifier matches a second change-identifier assigned to a second revision of the second file. Responsive to determining the negated first change-identifier matches the second change-identifier, a notification is sent, wherein the notification includes the first revision of the first file and the second revision of the second file.

### BACKGROUND

Software development frequently takes places collaboratively with multiple users editing source code files. Version control systems allow for sharing of a particular source code file among multiple users, and keeping a history of revisions to the particular source code file. For example, for every instance revisions are made to a file, the revisions are entered into a history log for the file. Typically, a single source code file can have an extensive history log due to continuous edits (i.e., entries and deletions) to the source code file. There are often instances where a first user deletes a portion of code from the source code file, only to have the deleted portion of code re-introduced into the source code by a second user. The re-introduction of the source code which was previously deleted by the first user may not be apparent to the second user, typically due to the large amount of content in the source code file. To avoid such a situation, the second user would have to manually review previous revisions made to a file to ensure that a proposed edit to the file does not conflict with a previous edit made by the first user.

### SUMMARY

Embodiments of the present invention disclose a method, computer program product and computer system for revision management. A computer-implemented method includes receiving a first file including a first revision, wherein the first revision differentiates the first file from a second file. A first change-identifier is assigned to the first revision. The first change-identifier assigned to the first revision is negated, and it is determined whether the negated first change-identifier matches a second change-identifier assigned to a second revision of the second file. Responsive to determining the negated first change-identifier matches the second change-identifier, a notification is sent, wherein the notification includes the first revision of the first file and the second revision of the second file.

### BRIEF DESCRIPTION OF THE DRAWINGS

FIG. 1 is a functional block diagram illustrating a distributed data processing environment, in an embodiment in accordance with the present invention.

FIG. 2 is a flowchart depicting operational steps of a version control program for managing file revisions, in accordance with an embodiment of the present invention.

FIG. 3a illustrates an example of a version control program receiving and assigning change-identifier to revisions of a file, in an embodiment in accordance with the present invention.

FIG. 3b illustrates an example of a version control program negating assigned change-identifiers to revisions of a file from FIG. 3a, in an embodiment in accordance with the present invention.

FIG. 3c illustrates an example of a version control program identifying matching change-identifiers between the negated change-identifiers and change-identifiers from previous revisions, in an embodiment in accordance with the present invention.

FIG. 4 is a block diagram of components of a computer system, such as the computer server of FIG. 1, in an embodiment in accordance with the present invention.

### DETAILED DESCRIPTION

Embodiments in accordance with the present invention allow for the revision management of files. For example, a source code file can include an extensive amount of code script, where the source code file is being developed through a collaboration of users. Typically, the source code file can go through multiple revisions, where the code script is altered through each of the multiple revisions. In situations where a revision is introduced, such as a deletion of a line of code in the code script, re-introduction of the deleted line into the code script by the user can occur, if the user does not thoroughly review past revisions of the source code file.

In some embodiments in accordance with the present invention, the delta of the current change to a file is compared with previous changes, and a warning is issued if the new changes appear to be re-introducing code that was previously removed. One advantage of this approach is that the check is made automatically against all known revisions, and is not subject to human error in determining whether a change is the inverse of a previous one.

Embodiments in accordance with the present invention recognize that when a file revision is made, the changes are recorded as differences between the previous version and the current version. In a desirable aspect, a system in accordance with the present invention works by comparing the reverses of the current set of differences to the differences from all previous revisions to the file. Calculating the reverse of a difference is a process frequently used in revision control systems to be able to perform an “undo” of a previous change.

The reverses of the current differences are used because the system is able to detect if something that was previously removed is being re-introduced. This is achieved by matching the inverse of the difference with any previous difference. This can be accomplished, for example, by fuzzy matching or probabilistic matching beyond a selected threshold. Embodiments in accordance with the present invention may also employ metadata related to the change in order to make warnings more applicable.

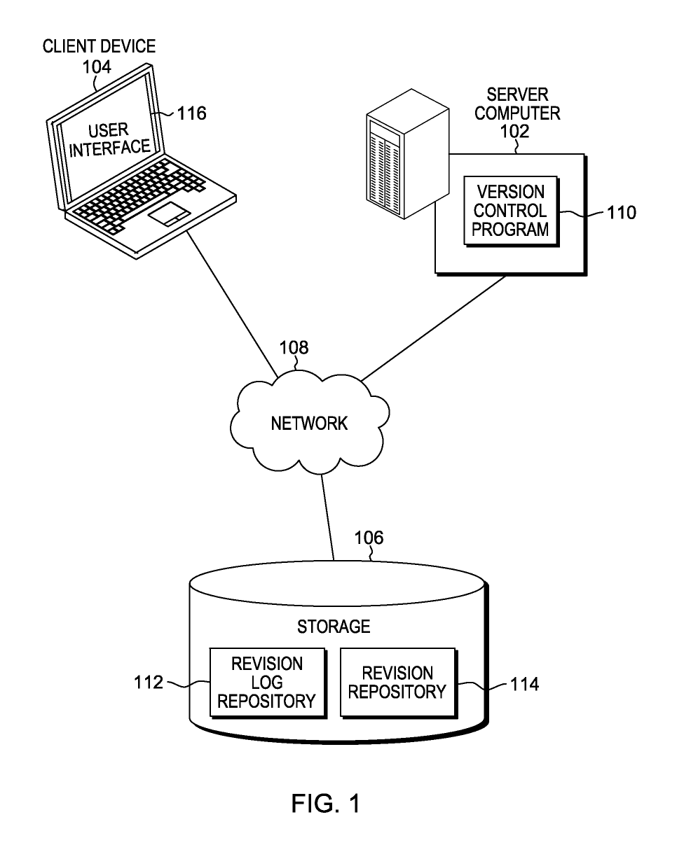

Example embodiments in accordance with the present invention will now be described in detail with reference to the drawing figures. FIG. 1 is a functional block diagram illustrating a distributed data processing environment. The distributed data processing environment includes server computer 102, client device 104, and storage 106 all interconnected over network 108.

Server computer 102 may be a desktop computer, a laptop computer, a tablet computer, a specialized computer server, a smartphone, or any other computer system known in the art. In certain embodiments, server computer 102 represents a computer system utilizing clustered computers and components that act as a single pool of seamless resources when accessed through network 108, as is common in data centers and with cloud computing applications. In general, server computer 102 is representative of any programmable electronic device or combination of programmable electronic devices capable of executing machine readable program instructions and communicating with other computer devices via a network. In this embodiment, server computer 102 has the ability to communicate with other computer devices to query the computer devices for information.

Version control program 110 residing in server computer 102 has the ability to identify conflicting proposed revisions to a file. In this embodiment, version control program 110 can receive a file (e.g., source code file) with associated revisions to the file. Version control program 110 can utilize history log repository 112 to identify previous versions of the file stored in revision repository 114 in storage 106. Each identified previous version of the file includes a uniquely assigned change-identifier for each revision compared to the previous version of the file. Version control program 110 can assign a change-identifier to each revision of the received file, negate the assigned change-identifiers of the received file, and compare the negated change-identifiers to the assigned change-identifiers of each previous version of the file. Version control program 110 can identify matching negated change-identifiers of the received file to the change-identifiers of each previous version of the file. Version control program 110 can then display the revisions associated with the matching change-identifiers to the user of version control program 110.

Client device 104 may be a laptop computer, a tablet computer, a netbook computer, a personal computer (PC), a desktop computer, a personal digital assistant (PDA), a smartphone, or any programmable electronic device capable of communicating with server computer 102 via network 108. Client device 104 can display various information of version control program 110 to the user via user interface 116.

Storage 106 includes revision log repository 112 and revision repository 114. In this embodiment, version control program 110 on server computer 102 communicates with storage 106 via network 108. In another embodiment, storage 106 can be located on server computer 102 along with version control program 110. Revision log repository 112 acts as an index for the multiple versions for each file stored in revision repository 114. An entry in a revision log repository 112 can include a file name, a version number for the file, a number of revision change-identifiers, and a user name responsible for the revisions performed for that particular version. Revision repository 114 includes each version of each file as stored by the user. Each version entry includes the complete file and uniquely assigned change-identifiers for each revision performed for that particular version. The assigned change-identifiers are stored as metadata along with the complete file for each version entry.

In general, network 108 can be any combination of connections and protocols that will support communications among server computer 102, client device 104, and storage 106. Network 108 can include, for example, a local area network (LAN), a wide area network (WAN), such as the internet, a cellular network, or any combination of the preceding, and can further include wired, wireless, and/or fiber optic connections. In one embodiment, version control program 110 can be a web service accessible via network 108 to a user of a separate device, such as client device 104. In another embodiment, version control program 110 may be operated directly by a user of server computer 102.

User interface (UI) 116 provides an interface between a user of client device 104 and version control program 110. User interface (UI) 116 can also provide an interface between the user of client device 104 and revision log repository 112. User interface 116 may be, without limitation, a graphical user interface (GUI) or a web user interface (WUI), for example, and can display text, documents, web browser windows, user options, application interfaces, and instructions for operation, and includes the information (such as graphic, text, and sound) a program presents to a user, and the control sequences the user employs to control the program. User interface 116 may also be mobile application software that provides an interface between a user of client device 104 and version control program 110. Mobile application software, or an “app”, is a computer program designed to run on smart phones, tablet computers and other mobile devices.

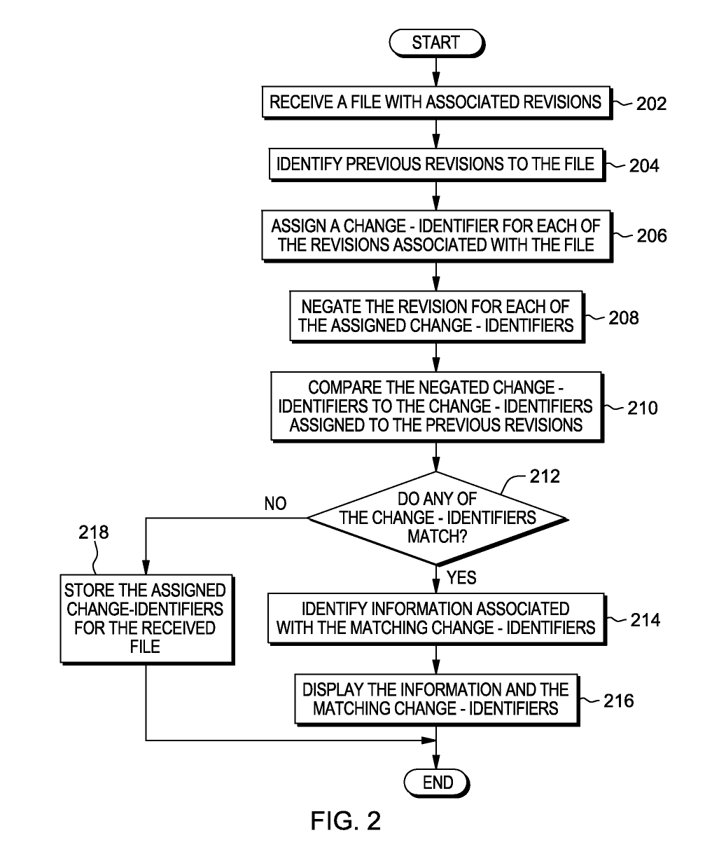

FIG. 2 is a flowchart depicting operational steps of a version control program for managing file revisions, in an embodiment in accordance with the present invention.

Version control program 110 receives a file with associated revisions (step 202). In this embodiment, version control program 110 receives a version of a source code file that the user of client device 104 intends to store in revision repository 114. The source code file which control program 110 receives includes multiple revisions to the source code along with the user information. User information can include a username and a time stamp for each revision of the received source code file.

Version control program 110 identifies previous revisions to the file (step 204). In this embodiment, version control program 110 can query revision log repository 112 to determine if any previous versions of the received source code file exist. If version control program 110 determines that previous versions of the received source code file do not exist, version control program 110 can send a request to revision log repository 112 to create an entry for the received source code file. As a result, this entry will serve as the base version of the source code file to which version control program 110 compares any future revisions to the source code file. If version control program 110 determines that previous versions of the source code file do exist, version control program 110 can query revision repository 114 for any available versions of the received source code file and the associated revisions. Version control program 110 can receive the versions of received source code file, associated revisions for each version, and user information for each version.

Version control program 110 assigns a change-identifier for each of the revisions associated with the file (step 206). In this embodiment, version control program 110 utilizes a pre-determined hash function to assign a change-identifier for each of the revisions associated with the received source code file Version control program 110 can convert a portion of source code into a hash code, where the hash code represents the change-identifier. Depending on whether the portion of source code is being introduced or removed, version control program 110 adds an operating symbol of addition (+) or subtraction (−) to the change-identifier, respectively. In one example, a revision to the file received in step 202 includes an addition of a new loop function. Version control program 110 utilizes a pre-determined hash function to assign a hash code (i.e., change-identifier), such as “ABBC”, for the new loop function being introduced in this particular revision to the source code file. Since the new loop function is an addition to the source code file, version control program 110 includes the addition (+) operating symbol with the hash code. As a result, version control program 110 assigns “+ABBC” as the change-identifier for this particular revision to the source code file.

In another example, a revision to the file received in step 202 includes a removal of a line of source code from the source code file. Version control program 110 utilizes a pre-determined hash function to assign a hash code (i.e., change-identifier), such as “CBZZ”, for the line of source code being removed in this particular revision to the source code file. Since the line of code is being removed from the source code file, version control program 110 adds the subtraction (−) operating symbol to the hash code. As a result, version control program 110 assigns “−CBZZ” as the change-identifier for this particular revision to the source code file.

Version control program 110 negates the revision for each of the assigned change-identifiers (step 208). In this embodiment, version control program 110 utilizes operating symbols along with the change-identifiers to represent a negation of a revision. For example, version control program 110 assigns “+ABBC” as the change-identifier for a particular revision to a source code file. Version control program 110 negates the assigned change-identifier for the revision by inverting the operational symbol to subtraction (−). As a result, version control program 110 determines the negated change-identifier for “+ABBC” is “−ABBC”. In another example, version control program 110 assigns “−CBZZ” as the change-identifier for a particular revision to a source code file. Version control program 110 negates the assigned change-identifier by inverting the operational symbol to addition (+). As a result, version control program 110 determines the negated change-identifier for “−CBZZ” is “+CBZZ”.

Version control program 110 compares the negated change-identifiers to the change-identifiers assigned to the previous revisions (step 210). Each previous version of the source code file with associated revisions, as identified by version control program 110 in step 204, includes change-identifiers for each of the revisions. Version control program 110 can compare the negated change-identifiers to the change-identifiers for each of the revisions of the previous versions of the source code files. A matching pair of change-identifiers represents a reversal of a previous revision. For example, if a user of client device 104 adds a line of source code in a revision that matches a line of source code previously removed, then the negated change-identifier for the added line of code matches the change-identifier for the previously removed line of code.

Version control program 110 determines if any of the change-identifiers match (decision step 212). In the event that version control program 110 determines change-identifiers match (“yes” branch, step 212), version control program 110 identifies information associated with the matching change-identifiers (step 214). If version control program 110 determines change-identifiers do not match (“no” branch, step 212), version control program 110 stores the assigned change-identifiers for the received file (step 218). Along with the assigned change-identifiers for the received file, version control program 110 can store the received file and the associated revisions as another version in revision repository 114. Version control program 110 can also create an entry in revision log repository 112 for the stored file in revision repository 114.

Version control program 110 identifies information associated with the matching change-identifiers (step 214). In this embodiment, version control program 110 can utilizes user information identified in step 204 to identify the user and the version of the source code file in which the conflicting revision was stored. Version control program 110 can highlight the revision associated with the negated change-identifier in the received source code file and highlight the revision associated with the change-identifier assigned to the previous version of the source code.

Version control program 110 displays the information and the matching change-identifiers (step 216). In this embodiment, version control program 110 sends a notification displaying the information associated with the matching change-identifiers to the user in user interface 116 of client device 104. The notification can include a report specifying the matching change-identifiers. Version control program 110 can display the matching change-identifiers, the user responsible for the revision associated with the matching change-identifier, and a portion of source code where the revision is located in the source code file. Version control program 110 can also query the user of client device 104 on whether to include the revision or to omit the revision from the current version of the source code file. When version control program 110 determines to include the revision, version control program 110 stores the source code file received in step 202, along with the revision with the matching change-identifier as another version in revision repository 114. In the event that version control program 110 determines to not include the revision, version control program stores the source code file received in step 202, without the revision, with the matching change-identifier as another version in revision repository 114.

In another embodiment, version control program 110 displays a portion of matching revision based on identified set parameters. For example, if a matching revision is associated with a previously identified defect in the source code of a previous revision, version control program 110 determines to display the defective matching revision associated with the matching change-identifier. Displaying the previously identified defect associated with the matching revision allows for the user of version control program 110 to view the identified defect and prevent the user from re-introducing the defect into another revision. For other revisions that version control program 110 determines as being not defective, version control program 110 can perform the changes to the revisions with the matching change-identifiers, without displaying them to the user.

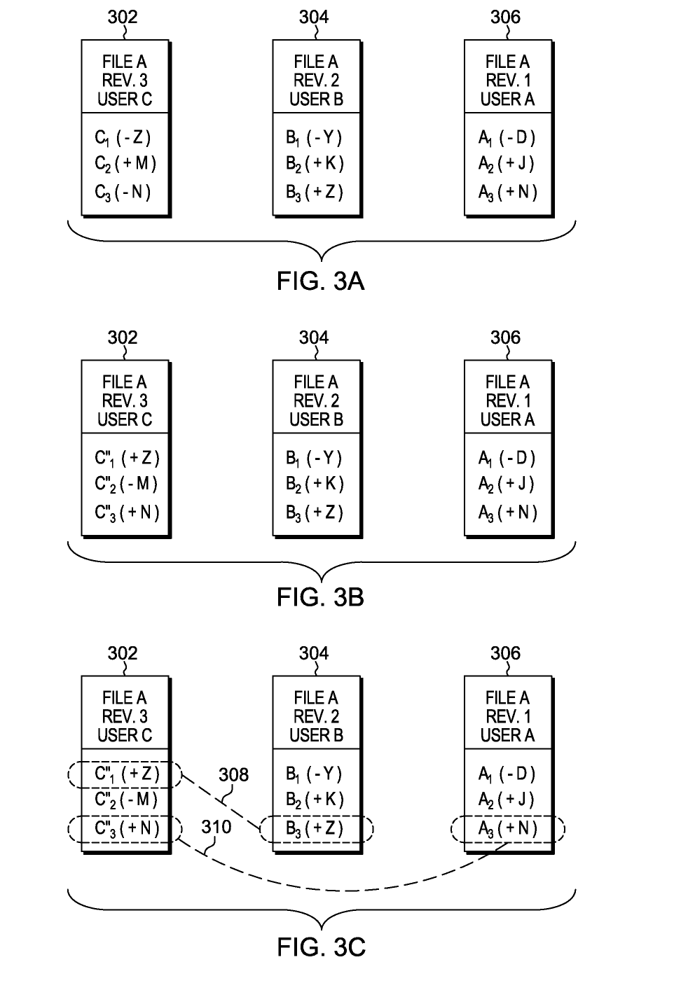

FIG. 3a illustrates an example of a version control program receiving and assigning change-identifiers to revisions of a file, in an embodiment in accordance with the present invention.

In this example, version control program 110 receives file 302 from user C, where file 302 is revision number 3 of a source code file. File 304 and file 306 represent the same source code file (File A) but as previous revisions number 2 and number 1, respectively. Version control program 110 assigns three change-identifiers (i.e., −Z, +M, and −N), which represent three alterations performed by user C to the source code file of file 302. Version control program 110 previously assigned three change-identifiers (i.e., −Y, +K, +Z), which represent three alterations performed by user B to the source code of file 304. Version control program 110 also previously assigned three change-identifiers (i.e., −D, +J, +N), which represent three alterations performed by user A to the source code of file 302. Version control program 110 utilizes the same pre-determined hash function to generate and assign change-identifiers to revisions for file 302, file 304, and file 306.

FIG. 3b illustrates an example of a version control program negating assigned change-identifiers to revisions of a file from FIG. 3a, in accordance with one embodiment of the present invention.

Continuing from FIG. 3a, version control program 110 negates the three assigned change-identifiers for file 302 The three change-identifiers representing the three alterations to file 302 were previously −Z, +M, and −N, as a result, version control program 110 negates the three assigned change-identifiers to +Z, −M, and +N. In this embodiment, +M represent adding a first line of code, while −Z and −N represent removing a second and a third line of code, respectively. With version control program 110 negating the three assigned change-identifiers for file 302, −M represents removing the first line of code, while +Z and +N represents adding the second and the third line of code, respectively. Version control program 110 compares the negated change-identifiers of file 302 to the change-identifiers of file 304 and file 306 to determine if any of the change-identifiers match. Matching change-identifiers represents a reversal of an alteration to the source code file between all the available revisions. For example, a line of source being added in revision 3 of file 302, which was previously removed in revision 1 of file 306.

FIG. 3c illustrates an example of a version control program identifying matching change-identifiers between the negated change-identifiers and change-identifiers from previous revisions, in an embodiment in accordance with the present invention.

Continuing from FIG. 3b, version control program 110 determines change-identifiers match between the multiple revisions (i.e., file 302, 304, and 306). Match 308 represents change-identifier +Z of file 302 matching change-identifier +Z of file 304. Since change-identifier −Z represents a removing of the second line of code and +Z represents an addition of the second line of code, version control program 110 determines there is a conflict between the file 302 and 304. Match 310 represents change-identifier +N of file 302 matching change-identifier +N of file 306. Since change-identifier −N represents a removing of the third line of code and +N represents an addition of the third line of code, version control program 110 determines there is a conflict between the file 302 and 306.

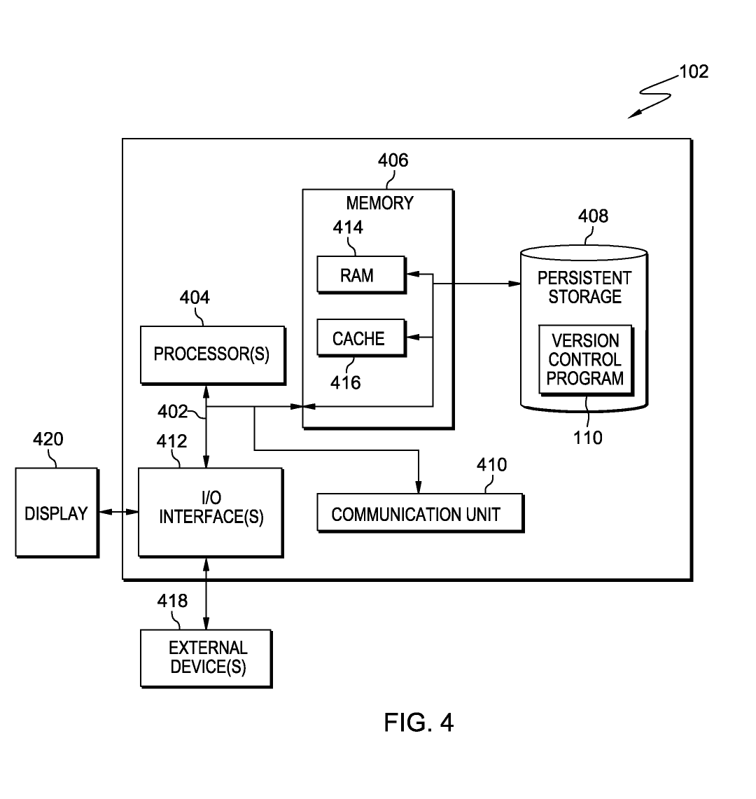

FIG. 4 depicts a block diagram of components of a computer, such as server computer 102, hosting version control program 110, in an embodiment in accordance with the present invention. It should be appreciated that FIG. 4 provides only an illustration of one implementation and does not imply any limitations with regard to the environments in which different embodiments may be implemented. Many modifications to the depicted environment may be made.

Server computer 102 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are examples of computer readable tangible storage devices. A storage device is any piece of hardware that is capable of storing information, such as, data, program code in functional form, and/or other suitable information on a temporary basis and/or permanent basis. In this embodiment, memory 406 includes random access memory (RAM) 414 and cache memory 416. In general, memory 406 can include any suitable volatile or non-volatile computer readable storage device.

Version control program 110 is stored in persistent storage 408 for execution by one or more of computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage medium that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including systems and devices within or controlled by server computer 102. In these examples, communications unit 410 includes one or more wireless network interface cards. Communications unit 410 may provide communications through the use of either or both physical and wireless communications links. Computer programs and processes, such as version control program 110, may be downloaded to persistent storage 408 through communications unit 410, or uploaded to another system through communications unit 410.

I/O interface(s) 412 allows for input and output of data with other devices that may be connected to server computer 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 may also connect to a display 420. Display 420 provides a mechanism to display data to a user and may be, for example, a touch screen or a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-6. (canceled)

7. A computer program product for revision management of files, the computer program product comprising:
one or more computer readable tangible storage media and program instructions stored on at least one of the one or more storage media, the program instructions comprising:
program instructions to receive a first file including a first revision, wherein the first revision differentiates the first file from a second file;
program instructions to assign a first change-identifier to the first revision;
program instructions to negate the first change-identifier assigned to the first revision;
program instructions to determine whether the negated first change-identifier matches a second change-identifier assigned to a second revision of the second file; and
responsive to determining the negated first change-identifier matches the second change-identifier, program instructions to send a notification, wherein the notification includes the first revision of the first file and the second revision of the second file.

8. The computer program product of claim 7, further comprising program instructions, stored on the one or more computer readable storage media, which when executed by a processor, to:
determine a first hash code for the first revision, wherein the first hash code is based at least on a hash function; and
determine the first hash code is the first change-identifier.

9. The computer program product of claim 7, further comprising program instructions, stored on the one or more computer readable storage media, which when executed by a processor, to:
identify the second file is a previous version of the first file; and
identify a user associated with the second file.

10. The computer program product of claim 7, wherein negating the first change-identifier assigned to the first revision comprises program instructions, stored on the one or more computer readable storage media, which when executed by a processor, to:
assign a first operational symbol to the first change-identifier; and
invert the first operational symbol, wherein inverting the first operational symbol represents a negation of the first revision.

11. The computer program product of claim 7, wherein sending a notification, wherein the notification includes the first revision of the first file and the second revision of the second file, further comprises program instructions, stored on the one or more computer readable storage media, which when executed by a processor, to:
identify the first revision of the first file is associated with a defect; and
send a notification to display the first revision of the first file associated with the defect.

12. The computer program product of claim 7, wherein sending a notification, wherein the notification includes the first revision of the first file and the second revision of the second file, further comprises program instructions, stored on the one or more computer readable storage media, which when executed by a processor, to:
identify an electronic device, wherein a first file including a first revision is received from the electronic device; and
send the notification to the electronic device.

13. A computer system for revision management of files, the computer system comprising:
one or more computer processors;
one or more computer readable storage media; and
program instructions stored on the computer readable storage media for execution by at least one of the one or more computer processors, the program instructions comprising:
program instructions to receive a first file including a first revision, wherein the first revision differentiates the first file from a second file;
program instructions to assign a first change-identifier to the first revision;
program instructions to negate the first change-identifier assigned to the first revision;
program instructions to determine whether the negated first change-identifier matches a second change-identifier assigned to a second revision of the second file; and
responsive to determining the negated first change-identifier matches the second change-identifier, program instructions to send a notification, wherein the notification includes the first revision of the first file and the second revision of the second file.

14. The computer system of claim 13, further comprising program instructions, stored on the one or more computer readable storage media, which when executed by a processor, to:
determine a first hash code for the first revision, wherein the first hash code is based at least on a hash function; and
determine the first hash code is the first change-identifier.

15. The computer system of claim 13, further comprising program instructions, stored on the one or more computer readable storage media, which when executed by a processor, to:
identify the second file is a previous version of the first file; and
identify a user associated with the second file.

16. The computer system of claim 13, wherein negating the first change-identifier assigned to the first revision comprises program instructions, stored on the one or more computer readable storage media, which when executed by a processor, to:
assign a first operational symbol to the first change-identifier; and
invert the first operational symbol, wherein inverting the first operational symbol represents a negation of the first revision.

17. The computer system of claim 13, wherein sending a notification, wherein the notification includes the first revision of the first file and the second revision of the second file, further comprises program instructions, stored on the one or more computer readable storage media, which when executed by a processor, to:
identify the first revision of the first file is associated with a defect; and
send a notification to display the first revision of the first file associated with the defect.

18. The computer system of claim 13, wherein sending a notification, wherein the notification includes the first revision of the first file and the second revision of the second file, further comprises program instructions, stored on the one or more computer readable storage media, which when executed by a processor, to:
identify an electronic device, wherein a first file including a first revision is received from the electronic device; and
send the notification to the electronic device.
